(19) United States
(12) Patent Application Publication
(10) Pub. No.: US 2013/0275167 A1
(43) Pub. Date: Oct. 17, 2013

(54) METHOD FOR RESEARCHING, CREATING, PRIORITIZING,EVALUATING, TESTING,INVESTING, IMPLEMENTING AND MANAGING NEW SOLUTIONS WITHIN AND AMONG BUSINESSES,PROJECTS OR GOVERNMENT ENDEAVORS

(71) Applicant: Romulo Rezende de Queiroz, Recife (BR)

(72) Inventor: Romulo Rezende de Queiroz, Recife (BR)

(21) Appl. No.: 13/447,509

(22) Filed: Apr. 16, 2012

(51) Int. Cl. G06Q 10/06

(52) U.S. Cl. 705/7.13

(57) ABSTRACT

A system for business or project management and planning which particularly relates to a system which provides a system with methodology to support management and the employees in the management of business and governmental organizations in organizing and controlling a project or process and measuring the results of innovative ideas and actions by creating a stimulating environment, providing adequate customizable internal process, analyzing organization's innovation process using key indicators, and allowing for a customizable system that will foster the continuous innovation within an organization.

### BACKGROUND OF THE INVENTION

1. Field of the Invention

The invention herein disclosed relates the provision of a system for business or project management and planning. More particularly it relates to a system which provides a system with methodology to support management and the employees in the management of business and governmental organizations in organizing and controlling a project or process and measuring the results of innovative ideas and actions.

2. Prior Art

### BACKGROUND OF THE INVENTION

While continued innovation and increased productivity are a mainstay of successful business and government entities, in most such organizations, innovative efforts, rather than being integral to the corporate of government immediate and long term strategy, are in fact disconnected from the company strategy. This state of disconnect is a major problem, especially for very large corporate and government entities.

In most organizations, be they business or government, a common belief is that innovations to operations or products or the like, happen in an ad hoc manner. As a consequence, management and employees in most such organizations organize their work using this assumption. Be it a correct or incorrect assumption, by organizing the workflow based on this assumption, such organizations can actually create the confusion and disorganization even if not initially present. As a consequence, most such business and government organizations lack a structured approach regarding any decision process on which novel or innovative ideas should be implemented and to subsequently ascertain of the ideas, which should not be implemented.

Consequently, decisions to move forward on one or a plurality of concepts can actually be driven by implementing them and letting some fail to ascertain which to pursue. As can be ascertained, this is a wasteful process and does not insure that the most innovative ideas survive since any implementation is dependent on the individuals putting the idea into practice. Even the best innovations can fail if the people implementing them lack the talent or skills to do so effectively.

Because of the disorganized flow and decision making with regard to innovation, most organizations also lack a cohering and structured approach on budgetary issues to nurture these innovation efforts. As such, many such organizations lose innovation opportunities they shouldn't because of their lack of previous structuring of financial resources.

Another impediment to nurturing innovation occurs because most organizations embark upon hasty or simply conventional implementation processes for their new ideas. This happens frequently because while the organization may embark or discover a novel concept, but they subsequently tend to employ rote or dictated internal processes. Such processes include using their conventional pricing strategies, employing their current communication strategy, assuming the use of existing distribution channels, employing existing organizational behavior, and simply using developed, in-house aspects of an implementation process as is employed with similar products, services, designs. Developing a novel or innovative product, service, or idea, and then using existing procedures and operations, instead of structuring the implementation process in a manner which may be required to nurture a new innovation, is another means to snatch defeat from the jaws of victory in the implementation process.

Many governments and countries in the world, in attempting to encourage effective innovation development and implementation, implement tax benefits or incentives calculated to foster such innovation within organizations. In spite of such good intentions, most governments lack the necessary technical standards or criteria to ascertain and control elements of innovation which can be considered integral to the innovation effort, and elements which should not be considered part of the encouraged innovative process. Such a poorly structured framework for monitoring the elements of criteria innovation is detrimental both for the government and the innovating organization and can be the cause for under utilization of such tax benefits or overutilization, which at a point, will exhaust the funds available to future or other innovators from the government.

In governments themselves, there exists another impediment to nurturing of innovation. Such governmental sectors of most economies lack an alignment between existing government processes and bureaucratic structure, and the public policies required to foster economic growth through innovation within the government management processes.

Government and bureaucracy have never adapted well to change since bureaucracies are configured to handle matters in a dictated and in varying systems of procedures and regulations. Consequently, most public entities, mired in their own procedural requirements of current operation, are not prepared to offer support of any new and innovative management processes which vary from the approved procedures within their administrative infrastructures.

As such, there exists an unmet need for a system and method to encourage and foster innovation, for both business and government, which will overcome the noted problems currently impeding successful generation and implementation of innovative ideas and methods. Such a system and method should start by providing a structure to the manner in which new ideas are generated which nurtures any innovation even before such innovations occur. Such a system should be able to ascertain and thereafter provide sufficient knowledge and the human resources necessary for nurturing innovations. Additionally, such a system should endeavor to be able to organize innovation nurturing according to the type of innovation rather than just implementing a one-size-fits-all approach.

Additionally, such a system should guarantee that any innovation occurs in a controlled environment and consequently not in ad hoc manner. To that end, such a system should employ indicators to identify which types of innovations are generated and allow those indicators to initiate corrective actions where needed during the innovation process.

Still further, such a system should provide an innovation management framework that may be employed for both public administration and for public policies concurrently, by the provision of a well-structured framework which will serve as a guide for any auditor, internal personnel, or external consultant.

### SUMMARY OF THE INVENTION

The disclosed method herein, implemented preferably using software adapted to the task and running on computers, provides a novel remedy for shortcomings of the nurturing of innovation noted above which currently affect business and government alike. The disclosed system and implementation method herein, employs a plurality of steps to effectuate a system of management perspectives. In a structured system, a structured step by step process is employed as a means to facilitate the understanding of the innovative process and to provide better organization of the innovation process.

In a first management perspective, the focus is upon providing innovators the proper information. Using this management perspective, the organization is enabled to ascertain the best occurring initiatives which can provide an innovator the necessary set of information and knowledge to be employed by innovators as their inspiration for the creation of new valuable ideas. Some organizations employ the term structured information or knowledge management, while others may find innovation inspiration in congresses, fairs, news media, and most importantly, via research, scientific or not.

A second innovation management perspective is that of incentive. Using this management perspective, customized to the organization and its innovators, the organization must ascertain what are the best ways to stimulate its innovators and collaborators to use the structured information of perspective number one, to best stimulate the innovator's imagination, in order that they generate good ideas, relative to the organization.

Money for many innovators encourages continual innovation. To that end, some organizations offer stock options since stock will increase in value was the organization does from innovations. Other organizations provide simple financial compensation either as a percentage of revenues from the innovations generated, or simply payment of some type of stipend for the innovator's ideas. In some cases, money may not be the most motivating factor to innovators in an organization. It might therefor be determined in this step that prizes or formal recognition to the innovator may be more important.

Depending on the organization, their industry or governmental dictate, and the innovators within the organization itself, encouragement of imaginative thinking will vary. In some cases, money may not be the most motivating factor to innovators in an organization. It might therefor be determined in this step that prizes or formal recognition to the innovator may be more important. In this last case, intrinsic motivation rather than extrinsic incentive tools (money, prizes, etc.) must be encouraged through management tactics, such as teamwork achievement commemoration, passion for company's values recognition, patriotic feeling praising, etc.

The important aspect of the nurturing perspective is for the organization to determine which is the correct incentive for the innovators in that organization, to generate the innovations which will provide an increase in value to the organization. A third management perspective for nurturing innovation, is that of imagination. Employing this management perspective, the organization must ascertain which are the best methods to foster and to structure the imaginative and creative thinking of the innovators within their own respective organization. For example, some organizations offer free time for creative work during regular day-to-day work. Other organizations provide an innovation lab infrastructure which is directed for use as a special space for teamwork and brainstorming. Other organizations employ specific technical methodologies, such as TRIZ.

A fourth management perspective in the system herein is the structuring of the organization's internal processes in order to manage and prioritize innovations and to ascertain which are the best ideas to be implemented. Some organizations employ databases to track ideas. Other uses employ a kind of “Idea Stock Market” where the peers of innovators within the organization may vote or “buy” stock in the ideas they prefer.

Others may use portfolio management techniques. The key element, however, in this step, is to ascertain and manage innovative ideas and technologies in the organization, and prioritize from the known innovations the most promising for the organization.

In a fifth management perspective in the system herein, investigation is required. In this management perspective, the organization must employ the correct skills in order to evaluate ideas and innovations and to shape those innovations into what are the best expected proposals to be tested. This needs to be done before implementation of an innovation or idea.

In effectuating this fifth perspective, the organization must ascertain that all qualitative and quantitative aspects of the idea or innovation, is covered in a determined scrutiny process. The greatest challenge during this step, is to reach a precise diagnoses on what are the best ideas, how the idea should be tested, how the idea should be implemented and finally, what is the value created by the innovation.

To achieve this step or perspective of the system herein, different methods may be employed which best fit the organization. Some organizations initiate specific training sessions on innovation management for an innovation review group of people within the organization. Other organizations go outside the organization and hire from specialists for the specific idea or project analysis. Other organizations use their own personnel to conduct a technical analysis of the idea or innovation. Finally, other organizations define and use specific methodologies that include a board of directors approval for these steps of the investigation process.

Since every organization is different, this step is also customized to the organization itself and thereafter, using the established process, the organization will evaluate the innovations as noted.

In a sixth part of the disclosed system of management perspectives, incubation of the innovation is the focus. Using this management perspective, the organization will employ techniques which will test the idea using lower cost initiative, before investing a greater amount of resources to implement the innovation being reviewed.

Again, while the step is part of the system herein, effectuating it is customized in a manner best suited to the organization. Some companies employ simple spreadsheet simulators for such evaluations. Other companies employ a CAD/CAM technology for evaluations. Other organizations may employ complete test labs for evaluations. Others may decide to use a complete city for a marketing test before implementing the innovation into a larger area like a state or a country.

Customization of this step is done by the organization itself based on its knowledge of its markets and customers and competitors. The determined regimen may be one or plurality of the above steps, or might be something different but relative to the organization establishing the incubation step.

In another management perspective of the system herein, investment by the organization is key. Employing this management perspective, the organization must be prepared to manage the necessary resources to guarantee the implementation processes as well as the whole innovation management process. Conventionally, many companies lack sufficient resources, or the knowledge of what resources will need to be invested in a project. They thus, are not sufficiently prepared in advance to provide the necessary resources when a good idea arises. The companies which employ the perspectives noted herein, will be better structured in these perspectives to ascertain the investment necessary for the innovation. Companies will normally have specific innovation fund, or designate a percentage of the total revenue toward such product development. Or they may provide a decision making process for resource allocation as fast as possible. An eighth management perspective is that of implementation.

Using this step in the process, the organization must make sure it has the necessary skills in order to correctly implement the proposed innovation. This management perspective will be customized to both the organization itself, and the innovation itself.

In the case of a new product, the main issue to be addressed are those related to marketing, pricing, distribution channels, communication, publishing and other product sales factors. In the case of a new process, the main issues to the organization will be related to the organizational change necessary to implement it the new process. In the case of a new design, the main issues will be related to the raw materials used, the molds, and other technical issues related to design changes. Consequently, the type of innovation and the organization itself will cause a customization of this step for each organization.

As an example, some organizations have specialists as employees to determine and implement the innovation. Other organizations hire specialists for this portion of the process. Still others outsource their implementation process. In any case, the organization putting this step in place will customize it to the organization itself, and then implement it on a regular basis.

As a ninth step or management perspective is innovation management. Using parameters custom to the organization, it must determine what are the main objectives, for each one of the previous eight perspectives, and what are the key indicators to be used to control these objectives.

This ninth perspective also includes the control of the kind of innovations created by the organization (design, new technology, new business model, new materials, new products, new business processes, etc.) and its correlation to the organizational strategic planning. It also includes the process of managing the process of working together with other organizations (some authors call this process “open innovation”).

Although it may seem logical that conventionally organizations would employ the noted perspectives in their innovation process, due to a lack of an organized approach, most organizations do not. The method herein therefor provides a means to provide a common framework, customized to both the organization and innovation.

The system herein, when employed by an organization, thus provides an effective methodology for encouraging and evaluating innovation for the organization which may be customized by the organization and thereafter structurally followed to provide innovation management.

With respect to the above description of innovation management, it is to be understood that the invention is not limited in its application to the details of operation nor the arrangement of the steps in the method set forth above or in the following descriptions or in the illustrations in the drawings. The various methods of implementation and operation of the disclosed innovation management system herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of methods and systems for carrying out the several purposes of the present invention to provide organizations a customized method or innovation management. Therefore, the objects and claims herein should be regarded as including such equivalent construction, steps, and methodology insofar as they do not depart from the spirit and scope of the present invention.

Further objectives of this invention will be brought out in the following part of the specification wherein detailed description is for the purpose of fully disclosing the invention without placing limitations thereon.

It is an object of the invention to provide a method to create an environment which stimulates the conditions for good ideas to arise from intelligence and that provides the necessary means to implement these ideas.

It is an additional object of the invention herein, to provide an organization with systemic innovation as an integral part of the organization operation through the provision of a system providing adequate internal processes.

Yet another object of the invention herein is to manage and control idea portfolios and implementation process of organizations such as business and government, through the provision of a system having customizable and adequate methodology for each kind of business or organizational needs.

A further object of this invention, is to provide a structured control and analysis system of an organization's innovation process through the use of key indicators, including organizational strategy alignment.

Yet another object of the system herein is to provide users with a structured framework to validate governmental incentive programs on innovation efforts or serve as a technical standard for any organization or institution on innovation initiatives.

A still further object of this invention is the provision of a system which is customizable to the using organization, which when followed, will foster continuous innovation within that organization.

These together with other objects and advantages which become subsequently apparent reside in the details of the provision of a system for business management and planning and method herein as more fully hereinafter described and claimed, reference being had to the accompanying drawings forming a part thereof, wherein like numerals refer to like parts throughout.

### BRIEF DESCRIPTION OF DRAWING FIGURE

FIG. 1 Depicts a graphic depiction of the system disclosed herein and the customizable methodology followed by users implementing it.

The accompanying drawing, which are incorporated in and form a part of this specification, illustrate embodiments of the multi-step system herein which is the subject matter of invention and together with the detailed description, serve to explain the principles of this invention.

### DETAILED DESCRIPTION OF THE PREFERRED EMBODIMENT OF THE INVENTION

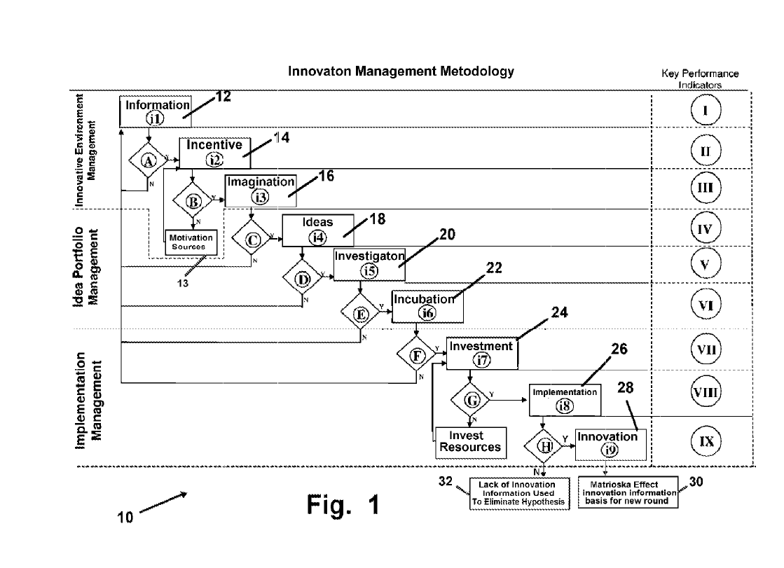

In FIG. 1, there can be seen, a graphic flow depiction of the method and system 10 herein which provides a customizable methodology for innovation encouragement and ongoing management. The system 10 is employed using printed material, electronic media, oral presentations, lists, and charts, to provide the information from the organization employing it, and to keep the innovators informed and using the system properly. The system 10 will employ printed material such as the chart depicted in FIG. 1, in hand held size as well as larger display sizes to keep the innovators on track. Ideally, software adapted to the task of maintaining the information and input from the innovators and at chosen times, sequentially move the innovators forward, will be employed where the steps shown are organized and the innovators moved forward to sequential next-steps over a determined duration of time. It is up to the organization employing the system 10 to choose to move forward and this can be done by designation of a supervising innovator or review by the organization management, or both, or some other means to decide to move to a next step.

In a first step 12, the system 10 will have the organization employing the system 10, provide the proper information from which to start the system 10 process after choosing innovators. In this step, innovators in a particular art or business area of the organization employing this system 10 are identified, and they are provided with initial information and knowledge, which may include a plurality of different hypothesis which could lead to an innovation, or could be information which has been shown not to work. This information provided in the first step 12 by the company, is to be employed by the chosen innovators as their inspiration for the creation of potentially valuable ideas. The provision of information to the innovators, by the organization employing the system 10, can be one or a combination of communications of information, including white papers, structured briefings from experts or knowledgeable people, providing for the innovators attendance at trade shows or industry meetings, providing discovered knowledge of an innovation 30, achieved by another company, or another team of innovators at the organization employing this system, the provision of data concerning research in an art which is of particular interest to the business or organization, or the provision of information concerning a failed employment of the system 10 and lack of innovation 32. The information provided in this first step 12, is provided by the organization hosting the system 10 as the basis for employing the system 10 toward an outcome.

In an incentive based second step 14, once the identified innovators in the organization implementing the system 10 have been provided the information 12, concerning the art or area of interest, the identified innovators are provided motivation from sources 13 as incentives adapted to stimulate the identified innovators and collaborators to use the provided information regarding the art provided in the first step 12, to best stimulate the innovator's imagination. This incentive provided in the second step 14 is generally an incentive identified as something to which each respective innovator will react and incentivize the innovator to work to generate good ideas, relative to the organization.

For example, in many large organizations, innovators such as engineers, will frequently fail to report an invention or innovation, because it simply requires them to perform more work than normal because they must write up the discovery or innovation for management, for little or no reward, and most probably setting them back in time for their regular job. In such an organization, the innovators being identified and provided with information in the art, will be given an incentive to innovate. In the case of many engineers, the incentive is to be named an inventor and thereby validate their engineering prowess with associates. Money too may be a factor as can vacation time or other rewards such as stock options.

Consequently using testing or questionnaire or other means, the particular incentives working best for a respective innovator are identified and offered to those innovators. The key is to identify what respective innovators value as an incentive, and to provide it.

A third step in the process is that of encouraging imagination 16. The organization employing the system 10 herein, endeavors to ascertain which are the best methods to foster and to structure the imaginative and creative thinking of the innovators within their own respective organization to arrive at ideas of innovation based on the information provided. From a pre-determined plurality of means of encouraging creative thinking for identified innovators, each respective innovator is provided one or a plurality of determined imagination encouraging items. These may also be determined by testing or questioning innovators in advance, or by tracking known innovators and ascertaining what activity best fosters their imagination. Currently a preferred group of means to encourage imagination in innovators includes one or a combination of, providing innovators free time for creative work during regular hours, providing a lab infrastructure for employment by innovators or teams, providing meeting rooms and times for innovators. As noted, depending on the organization, and their industry, the encouragement of imaginative thinking will vary.

Consequently, such encouragement means will be ascertained prior to the implementation of this third step 16, and thereafter identified encouragers of imagination related to specific identified innovators in the organization, will be implemented. For instance an organization may have a dozen innovators identified, will identify to what identified imagination encouragers each respective innovator best reacts. In implementing this third step 16, each innovator would be provided with one or a plurality of pre identified imagination encouragers likely to elicit ideas for innovation based on provided information.

A fourth step 18 in the system 10 used by an organization, management perspective in the system herein is prioritizing the chose ideas. In this step, the structuring of the organization's internal processes is undertaken prior to implementation of the system 10. Thereafter, using the system 10 herein, ideas generated in the prior steps, are prioritized to be worked upon by the innovators using the predetermined method and criteria determined by the organization. One preferred mode of idea prioritization, is to employ databases to track ideas to eliminate duplication, associate similar wording, and/or to match the ideas to predetermined organization needs for products using the words using a database and sorting software. Or, provide the ideas from the innovators from the database to peers of innovators will vote on which idea to move forward and software adapted to the task which operates the system 10 will provide screens and documentation to the innovators to prioritize and track the innovator's ideas.

As shown in FIG. 1, a fifth management step 20 is employed in the form of investigation. Using this step, the first of the prioritized ideas from the fourth step 18, are evaluated and those that best expected to yield novel results are proposed for testing. In employing this fifth step 20, the organization implementing this system 10, will pre-ascertain means for qualitative and quantitative determination of aspects of an idea or innovation, which render it more valuable to the organization than others concurrently evaluated. As noted, some organizations may initiate review groups of people within the organization, other organizations go outside the organization and hire from specialists for the specific idea or project analysis, others may use their own personnel to conduct a technical analysis of the idea or innovation. In any case, a systematic means to evaluate ideas is arrived at, and thereafter employed in this fifth step 20 of investigation. This again would be done by a database and software and/or a peer review group.

In a subsequent sixth step 22, of the system 10 herein, incubation of the innovation is addressed. In this step, using pre-determined means to test the idea in the organization, the idea may be tested before greater amount organization resources are employed to implement the innovation or idea being reviewed.

As noted, each organization must predetermine the best means of effectuating this step in a manner best suited to the organization. The predetermined means for incubation is then systematically employed to ideas. Currently, preferred means of incubation for organizations can include on or a combination of employing simple spreadsheet simulators for such evaluations, or employing a CAD/CAM technology for evaluations, or employing test labs for evaluations, or conducting a marketing test.

In a seventh step 24, of the system 10 herein, investment by the organization is a key factor in order to ascertain if the organization is prepared to manage the necessary resources to guarantee the implementation processes for the idea. In this step, the organization employing this system 10, will ascertain if the organization can muster sufficient financial and management resources to move the idea forward commercially.

In an eighth step 26, implementation of the idea is addressed. Employing this eighth step 26, the organization employing this system 10, will employ pre-derived criteria to the idea, and thereby make sure the organization has the personnel with necessary skills and equipment in order to correctly implement the proposed innovation or idea. This eighth step 26 of implementation will employ pre-determined or currently ascertained criteria customized to both the organization itself, and/or the innovation itself.

Such criteria may include one or a combination of marketing, pricing, distribution channels, communication, publishing and other product sales factors. These factors are employed as relational to the organizational change necessary to implement it the new process or idea.

In a ninth step 28 in the system 10, innovation management of the idea is addressed. Again, using pre-determined parameters custom to the organization employing the system 10, using executive committee, research from employees or consultants, or other information, it must be determined what are the main objectives, as relating to each of the eight previous steps, and what are the key indicators to be employed to control these objectives.

This ninth step 28, includes one or a combination of objectives, including controlling the kind of innovations created by the organization (design, new technology, new business model, new materials, new products, new business processes, etc.) and a relational correlation to the organizational strategic planning and determined need for the innovation.

Another aspect of the system 10 herein, can best be described as the “Matrioska Effect.” Matrioska are well known as small Russian dolls that like a puzzle, fit one into another from the smallest to the largest. Removing each doll from the larger one, provides a discovery of a new doll to view and remove. In managing innovation, this same effect can also be a positive outcome of the system 10 herein.

For example, frequently, a new technology created by one company, serves as the inspiration for another firm or person, and as a starting point for a subsequent innovation based on the first. The inventor of the innovation, may have employed the system 10 herein, to create its innovation as depicted as the ninth step 28 where innovation management occurs. This may be the end of the process for the innovating first company, however using the innovation reached at the ninth step 28 by the first company, can have the Matrioska Effect upon the subsequent company. This second company has the benefit of viewing and understanding the innovation arrived at in the ninth step 28 by the first company. This subsequent company, or a new team of innovators at the first company, will use the innovation reached in this ninth step 28, as a basis or starting point to further innovate. Using the derived innovation 30, the subsequent company or team, will start a new round of the system 10 herein all over again, by taking the derived innovation and using it as new information in a step 1, 12, but arriving at a subsequent innovation in their respective ninth step 28.

Alternatively, should the same organized structure of the system 10 herein, reach the ninth step 28, but fail to provide an innovation which was expected, failure is not necessarily a valueless occurrence. Indeed, many scientist and innovators well know, that should a premise being researched fail to yield the predicted outcome or innovation, that knowledge can be put to work in a manner to start a new cycle of innovation where one premise has been eliminated. Where a hypothesis fails 32 to arrive at a predicted innovation, an innovator may use that information to eliminate a path of research or innovation in another round, using that information 12 derived from the outcome of the ninth step 28, as the staring point with the knowledge of what does not work, and in search of what will provide the innovation sought. This knowledge of what will not work or innovate, is especially valuable where originally there were two or more theories or trains of thought as to what problem needed solving or what path should be taken to innovate. Eliminating one of the original plurality, can be valuable knowledge for a new team to employ the system 10 herein to find the real innovation in a second or subsequent round of the system 10 starting with the derived information of what is not innovative in the first step 12.

The system 10 can also be employed as a way to monitor the innovation process through key performance indicators (KPIs). Following, I summarize some examples of KPIs that can be used to monitor each of the nine steps above or the entire group of steps as shown in FIG. 1.

I—Number of accesses into a information database, time spent with customers learning about their needs, number of benchmarking made with other organizations, number of training hours of employees, average school level of the employees within an organization, number of PhDs, etc.;

II—Value of total incentives given to employees involved with the innovation process, value of ideas given by the people engaged in the innovation process, value of stock options offered to employees, etc.;

III—Number of free hours employees spent on brainstorming or doing a creative work, number of people involved in the innovation process of the organization, time dedicated to creative work, etc.;

IV—Volume of ideas generated, number of ideas approved to be implemented, number of new value added services identified, etc.;

V—Number of ideas identified that became a project or joined a project, percent of projects advanced from stage to stage of the innovation decision process, mix of projects of an organization, etc.;

VI—Percentage of prototypes or pilot projects created over the number of approved ideas, number of prototypes that became a product, average value per prototype created, etc.;

In this system 10 of innovation management and methodology, innovators are thus encouraged to ascertain new and profitable ideas and technologies. These ideas and technologies thereafter undergo a systematic review to ascertain if the idea or innovation can be successfully implemented by the organization employing the system herein.

Although it may seem logical that conventionally organizations would employ the noted perspectives in their innovation process, due to a lack of an organized approach, most organizations do not. The method herein therefor provides a means to provide a common framework, customized to both the organization and innovation.

While all of the fundamental characteristics and features of the method have been shown and described herein, with reference to particular embodiments thereof, a latitude of modification, various changes and substitutions are intended in the foregoing disclosure and it will be apparent to those skilled in the art after reading this disclosure, that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

1. A method, implemented using a computer running one or more software programs, for an organization having innovators in its ranks to manage and encourage innovation to a product or service from information provided by the organization to the innovators, comprising:
designating a plurality of innovators to work on an innovative task;
employing printed or electronic or oral media to provide said innovators information as a starting point for said innovative task;
providing a motivator to assist each respective innovator to work on said innovative task;
from a group of identified incentives to encourage said innovators to conceive ideas for innovation, based on said information, providing each of said innovators, one or a plurality of such incentives to encourage free thinking to said innovators;
employing one or both of a database, coupled to the computer and comparing said ideas using at least a first software program that utilizes predetermined sorting and comparison criteria and a peer group voting on said ideas, to prioritize a first idea and a subsequent idea for said innovators to work on;
investigating said first idea and said subsequent idea to ascertain one or a plurality of said ideas most likely to provide value to said organization based on said organization's pre-determined methodologies for qualitative and quantitative determination to provide value to said organization;
employing said organization's pre-determined methodologies implemented using a second software program via the computer to test said ideas most likely to provide value to said organization before a greater amount of said organization's resources are later employed to implement said idea chosen most likely to provide value to said organization;
said organization reviewing said ideas most likely to provide value to said organization, to ascertain if the organization can muster financial and management resources sufficient to implement said ideas most likely to provide value to said organization;
said organization employing pre-derived criteria to ascertain whether said organization has personnel with necessary skills and equipment to correctly implement the idea most likely to provide value to said organization; and
from the ideas most likely to provide value to said organization for which the organization has personnel with necessary skills and equipment to correctly implement the idea, said organization choosing said ideas which have a relational correlation to the organization's previously determined strategic planning relating to a determined need for the chosen innovation.

2. The method of claim 1, wherein the group of identified incentives consists of: money, stock options, percentage of revenue, and a stipend.

3. The method of claim 1, wherein the group of identified incentives consists of: a prize, vacation, and formal recognition.

4. The method of claim 1, wherein the group of identified incentives consists of: free time for creative work, innovation lab infrastructure, and TRIZ.

5. The method of claim 1, wherein the ideas are tested using a spreadsheet simulator.

6. The method of claim 1, wherein the ideas are tested using a test lab.

7. The method of claim 1, wherein the ideas are tested using CAD/CAM technology.

8. The method of claim 1, wherein the ideas are tested using market testing or market analysis.

9. The method of claim 1, wherein a Matrioska Effect is generated within the organization.

10. The method of claim 1, wherein a Matrioska Effect is generated within a second organization.
